(19) United States
(12) Patent Application Publication
(10) Pub. No.: US 2015/0243195 A1
(43) Pub. Date: Aug. 27, 2015

(54) DOOR MESSAGING SYSTEM

(71) Applicants: Ray Escobedo, Lakeland, FL (US); Dallaz Ray Escobedo, Lakeland, FL (US); Chelsea Rae Escobedo, Lakeland, FL (US)

(72) Inventors: Ray Escobedo, Lakeland, FL (US); Dallaz Ray Escobedo, Lakeland, FL (US); Chelsea Rae Escobedo, Lakeland, FL (US)

(21) Appl. No.: 14/191,768

(22) Filed: Feb. 27, 2014

(51) Int. Cl. G09F 11/23; G09F 23/00

(52) U.S. Cl. CPC G09F 11/23; G09F 23/00

(57) ABSTRACT

A door messaging system comprising: an outside message viewer, which depicts an exterior message; an interior message indicator; and a message selector, with a message selector includes a rotating dial engaging a rotating scroll of messages, where the rotating dial enables the rotating of messages on the inside message indicator and messages on the exterior message where the message indicator and exterior messages are identical. A plurality of screws may support and secure the door messaging system through an opening in a door. Also, a series of dows may support and enable the rotation of scrolling messages on the interior message indicator and exterior message. The door messaging system may also include a sound buffer, where the sound buffer is centered between the message indicator and the exterior message.

### BACKGROUND OF THE INVENTION

1. Field of Invention

The present invention relates to a messaging system that provides a door message posted on the exterior of a door.

2. Description of Related Art

Presently many situations require a door message on the exterior of a door. Some of the common applications of door messaging relate to hotels, motels and offices. Commonly messages may be placed on a doorknob or posted on the outside surface of the door indicating a particular condition with respect to the room that the door provides entrance thereto. Typical signs in a hotel include a do not disturb sign indicating that the guest does not want to be disturbed or alternatively a service sign may be placed on the doorknob indicating service is requested in a particular room. In office settings many times door messages indicate whether a meeting is taking place or if the conference room is occupied at a particular time. Again this is most commonly accomplished by using a sign on the exterior of the door to notify the general public of the activities in the room.

Due to a door sign being used a common communication device, it would be advantageous to have a sign system integrated within the door that indicates the room condition with respect to the particular door.

### SUMMARY OF THE INVENTION

The present invention relates to a door messaging system comprising: an outside message viewer, which depicts an exterior message; an interior message indicator; and a message selector, with a message selector includes a rotating dial engaging a rotating scroll of messages, where the rotating dial enables the rotating of messages on the inside message indicator and messages on the exterior message where the message indicator and exterior messages are identical. A plurality of screws may support and secure the door messaging system through an opening in a door. Also, a series of dows may support and enable the rotation of scrolling messages on the interior message indicator and exterior message. The door messaging system may also include a sound buffer, where the sound buffer is centered between the message indicator and the exterior message.

### BRIEF DESCRIPTION OF DRAWINGS

FIG. 1 depicts a door sign in accordance with the present invention.

FIG. 2 depicts an inside message indicator in accordance with the present invention.

FIG. 3 depicts a cross-section view of the inner components of the door messaging system in accordance with the present invention.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DETAILED DESCRIPTION

The present invention relates to a door messaging system that posts a message to the exterior of a door while providing a message indicator on the inside of the door. The message indicator provides a means in the form of a rotating dial that rotates a scrolling message that coincides with an exterior message that is visible from the exterior of the door. This system allows an individual or group within a room to post an outside message that is visible on the exterior of the door while the door is closed. This system therefore enables a user to post outside messages as desired through a scrolling screen of messages.

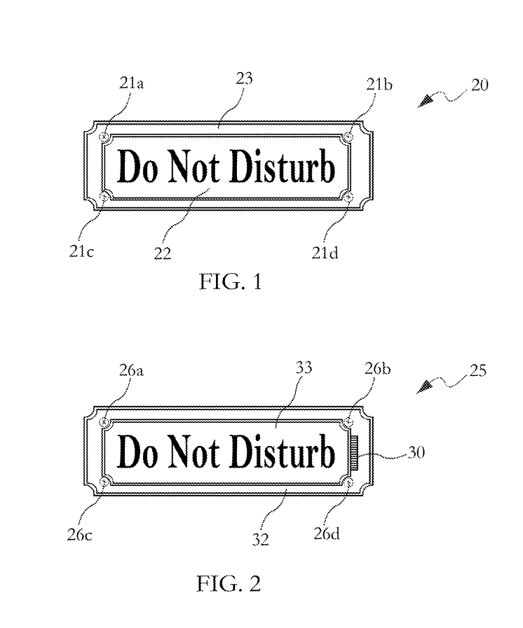

With respect to FIG. 1, an exterior door Message 20 is depicted. The exterior door Message 20 includes a Border 23 and a Message 22. The exterior Message 22 is visible on the exterior side of the door. The exterior Message 22 is seen through a cutout provided within the door and a border surrounds the message. This Border 23 and exterior Message 22 may be supported through the use of four screws, 21a, 21b, 21c, 21d.

With respect to FIG. 2, an interior door message Indicator 25 is shown. The interior door message Indicator 25 includes a Message 33 surrounded by Border 32. Similarly screws 26a, 26b, 26c and 26d support this signage on the interior of the door through an opening in the door. The interior message Indicator 25 includes a message Selector 33 in the form of a dial. The message Selector 30 empowers a user to scroll through messages available on a rolling scroll within the door messaging system. As a consequence, the message shown on the interior message Indicator 25 replicates or is exactly the same as the exterior Message 20.

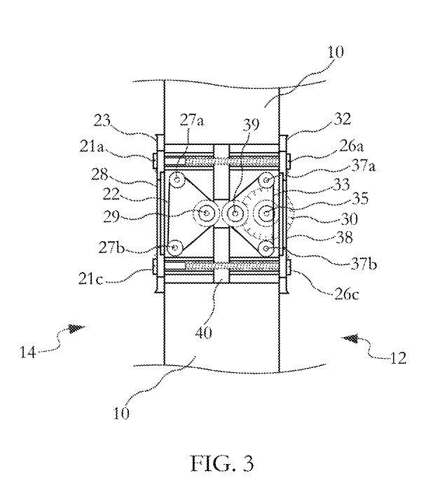

The coordination of the messaging system is accomplished through the use of scrolling messages that are shown on the interior opening between the exterior Message 20 and the interior message Indicator 25 as shown in FIG. 3. FIG. 3 shows a cross-section of the door messaging system according to the present invention. A Door 10 includes the messaging system that is connected into an opening in the Door 10. A sound Buffer 40 is positioned at a center position of the message system of the present invention.

An interior Side 12 includes the message selector Dial 30 extending from the surface of the Door 10 and rotates a Scroll 33. The Scroll 33 extends over Dows 37a, 37b and 39. The Dial 39 engages with the selector Dial 30 and rotates the scrolling Message 33 that is visible through a glass or a Plexiglas Window 38. This Window 38 allows the user to view the interior message Indicator 25 indicating the message that is displayed and coincides with the exterior Message 20. This exterior Message 20 is shown through a similar glass or Plexiglas Window 28 on an exterior Side 14. A scrolling Message 22 is fed through Dows 27a, 27b and 29. The dow 29 engages with the Wheel 39 and accordingly the scrolling messages rotate in concert with each other while a user uses the message Selector 30. Also seen from this sectional view is the respective Borders 23 and 32 on each side of the Door 10. The screws are also shown that extend through the opening securing the door messaging system in a stable secure place. This particular system enables a user to select a particular message which is visible on the interior of the door indicating the exterior message that is shown on the exterior of the door. The instant invention has been shown and described in what it considers to be the most practical and preferred embodiments. It is recognized, however, that departures may be made there from within the scope of the invention and that obvious modifications will occur to a person skilled in the art.

1. A door messaging system comprising:
an outside message viewer, which depicts an exterior message;
an interior message indicator; and
a message selector, where the message selector includes a rotating dial engaging a rotating scroll of messages, where the rotating dial enables the rotating of messages on the interior message indicator and messages on the exterior message where the message indicator and the exterior messages are identical.

2. The door messaging system according to claim 1, where a plurality of screws support and secure the door messaging system through an opening in a door.

3. The door messaging system according to claim 1, wherein a series of dowels support and enable the rotation of scrolling messages on the interior message indicator and exterior message.

4. The door messaging system according to claim 1, further including a sound buffer, where the sound buffer is centered between the message indicator and the exterior message.
